(19) United States
(12) Patent Application Publication
(10) Pub. No.: US 2025/0378263 A1
(43) Pub. Date: Dec. 11, 2025

(54) TECHNIQUES FOR EFFECTIVELY ELIMINATING INPUT SIZE LIMITS OF MACHINE LEARNING MODELS

(71) Applicant: Apple Inc., Cupertino, CA (US)

(72) Inventors: Xiaohui TAO, Bellevue, WA (US); James BYUN, Los Angeles, CA (US); Jason GE, Seattle, WA (US); Wentao WU, Millbrae, CA (US); Yang ZHAO, Palo Alto, CA (US)

(21) Appl. No.: 19/083,752

(22) Filed: Mar. 19, 2025

Related U.S. Application Data
(60) Provisional application No. 63/657,845, filed on Jun. 8, 2024.

(51) Int. Cl. G06F 40/166; G06F 16/334; G06F 40/289

(52) U.S. Cl. CPC G06F 40/166; G06F 16/3344; G06F 40/289

(57) ABSTRACT

The present disclosure generally relates to implementing machine learning models. More particularly, the described embodiments provide techniques for effectively eliminating input size limits of machine learning models. Some techniques are for processing text using machine learning (ML) models.

### CROSS-REFERENCE TO RELATED APPLICATIONS

The present application claims priority to U.S. Provisional Patent Application Ser. No. 63/657,845, entitled “TECHNIQUES FOR EFFECTIVELY ELIMINATING INPUT SIZE LIMITS OF MACHINE LEARNING MODELS” filed Jun. 8, 2024, which is hereby incorporated by reference in its entirety for all purposes.

### FIELD

The described embodiments relate generally to implementing machine learning models. More particularly, the described embodiments provide techniques for effectively eliminating input size limits of machine learning models.

### BACKGROUND

Large Language Models (LLMs) have revolutionized natural language processing tasks, in that they offer remarkable capabilities in generating human-like text based on input prompts. However, despite their prowess, these models still grapple with certain limitations, particularly concerning input sizes.

One primary constraint pertains to computational resources. Specifically, LLMs demand substantial computational power in order to effectively process input data. While advancements have been made to optimize model architectures and increase efficiency, there are still practical limits to the amount of data these models can handle within a reasonable timeframe. Current hardware capabilities also place bounds on the input sizes that LLMs can effectively process without sacrificing speed or accuracy.

Another significant limitation arises from memory constraints. In particular, LLMs rely on vast parameter spaces to store the learned patterns and associations between words and phrases. This functionality necessitates large amounts of memory to accommodate the models' parameters and to effectively process inputs that are received. In this regard, as input sizes increase, so does the demand for memory, thereby posing challenges for both training and inference stages.

Additionally, there are practical considerations regarding the usability of LLMs with large input sizes. In particular, existing user interfaces through which users interact with these models often impose their own limitations. For example, user interfaces, whether graphical or command-line-based, typically struggle to handle and display large amounts of text efficiently, thereby impacting user experience and practicality.

In sum, while LLMs continue to push the boundaries of natural language processing, their current limitations in handling large input sizes underscore the ongoing need for advancements in computational resources, memory management, and user interface design to fully unlock their potential. Overcoming these challenges is important for realizing the promise of LLMs in tackling increasingly complex language tasks across various domains.

Accordingly, what is needed are improved techniques for effectively expanding input sizes of machine learning models.

### SUMMARY

The described embodiments relate generally to implementing machine learning models. More particularly, the described embodiments provide techniques for effectively eliminating input size limits of machine learning models.

One embodiment sets forth a method for processing text using machine learning (ML) models. According to some embodiments, the method can be implemented by a server computing device, and includes the steps of (1) receiving a query from a client computing device, wherein the query comprises a request to generate a summary of text content included in the query, (2) determining that a size of the text content exceeds an input limit associated with an ML model to be utilized to generate the summary, (3) separating the text content into a plurality of text segments, wherein each text segment of the plurality of text segments is sized in accordance with the input limit, (4) for each text segment of the plurality of text segments: (i) generating, using the ML model, a respective text summary based on the text segment, and (ii) adding the respective text summary to a plurality of text summaries, (5) generating the summary based on the plurality of text summaries, and (6) causing the summary to be output by way of a user interface on the client computing device.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1A illustrates an application process for interacting with a system.

FIG. 1B illustrates an application process for interacting with a system.

FIG. 1C illustrates software architecture of a device that includes Application Programming Interface (API) calling instructions.

FIG. 1D illustrates software architecture of a system that includes an API and implementation instructions.

FIG. 1E illustrates an application process for interacting with a system using API calling instructions.

FIG. 1F illustrates an application process for interacting with a system using API calling instructions.

FIG. 1G illustrates a block diagram of different components of a system that can be configured to implement the various techniques described herein, according to some embodiments.

FIGS. 2A-2E illustrate conceptual diagrams of how a server computing device can effectively eliminate input size limits of machine learning models, according to some embodiments.

FIG. 3 illustrates a method for effectively eliminating input size limits of machine learning models, according to some embodiments.

FIG. 4 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

The described embodiments relate generally to implementing machine learning models. More particularly, the described embodiments provide techniques for effectively eliminating input size limits of machine learning models.

Implementations and techniques within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, application extensions, widgets, processes, software, software modules and/or components.

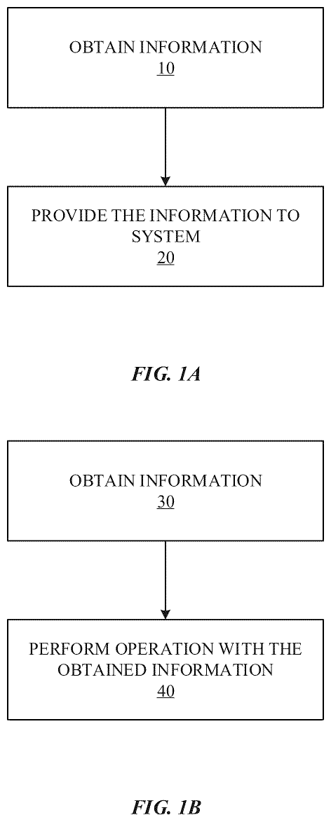

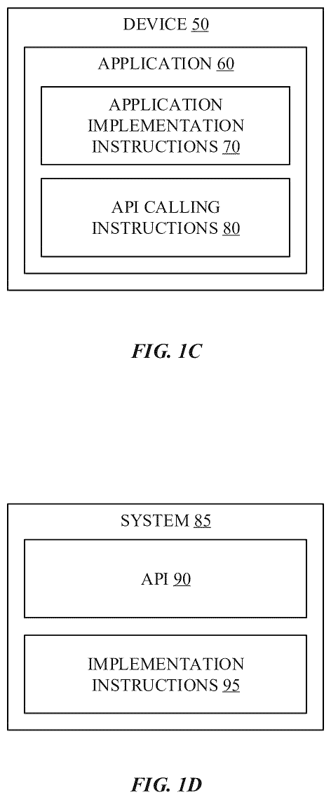

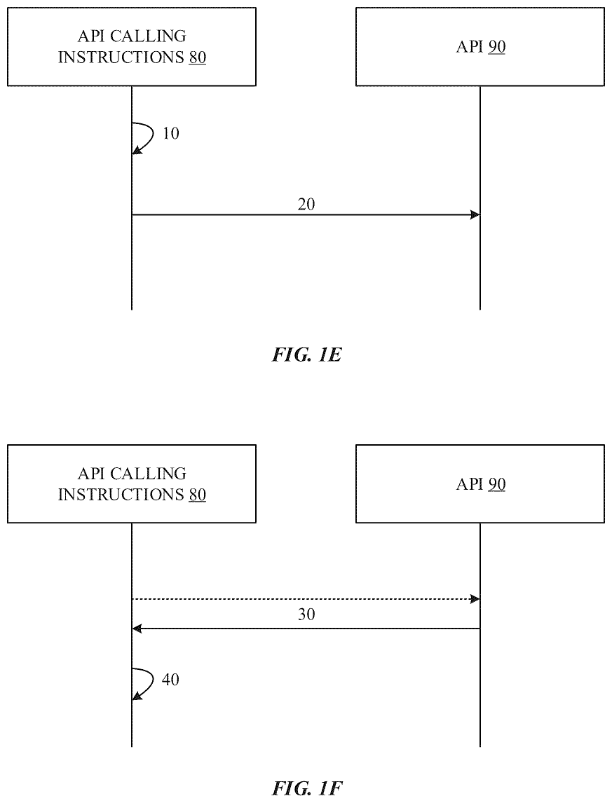

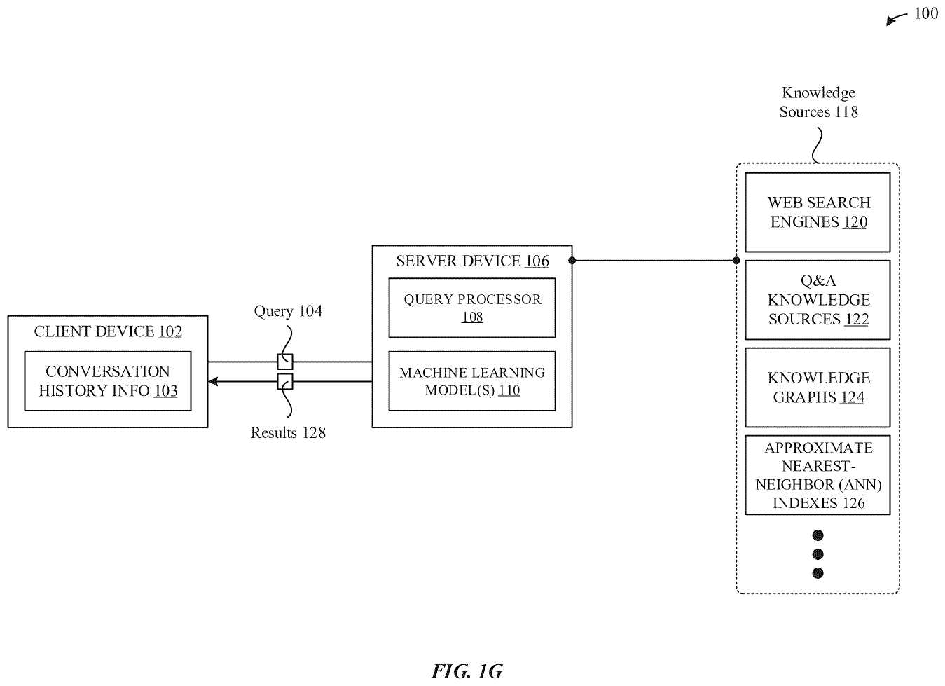

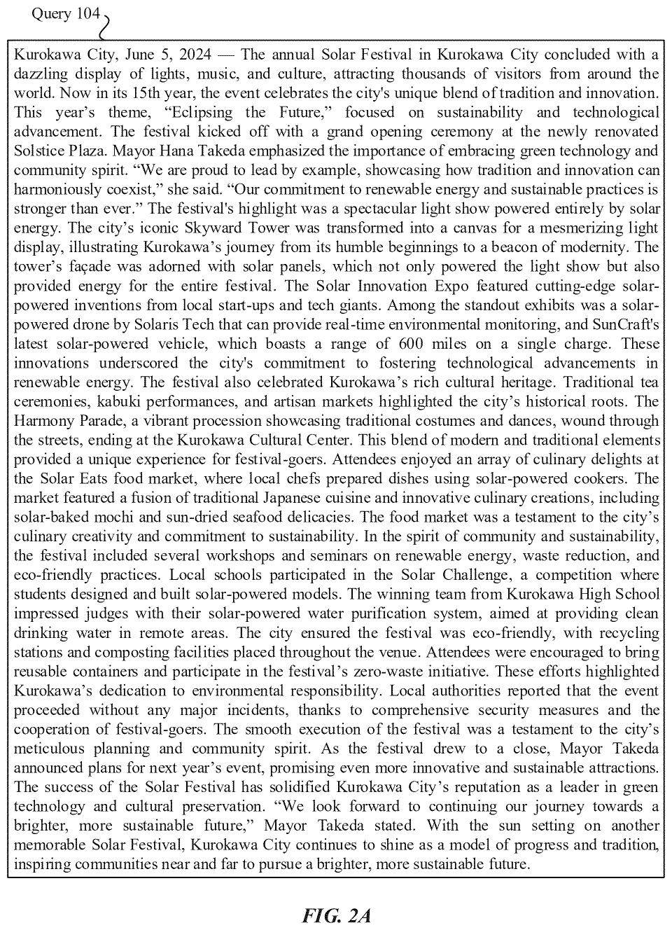

Implementations within the scope of the present disclosure include a computer-readable storage medium that encodes instructions organized as an application (e.g., application 60) that, when executed by one or more processing units, control an electronic device (e.g., device 50) to perform the method of FIG. 1A, the method of FIG. 1B, and/or one or more other processes and/or methods described herein.

It should be recognized that application 60 (shown in FIG. 1C) can be any suitable type of application, including, for example, one or more of: a voice assistant application, a browser application, an application that functions as an execution environment for plug-ins, widgets or other applications, a fitness application, a health application, a digital payments application, a media application, a social network application, a messaging application, a text content summarization application, and/or a maps application. In some embodiments, application 60 is an application that is pre-installed on device 50 at purchase (e.g., a first party application). In other embodiments, application 60 is an application that is provided to device 50 via an operating system update file (e.g., a first party application or a second party application). In other embodiments, application 60 is an application that is provided via an application store. In some embodiments, the application store can be an application store that is pre-installed on device 50 at purchase (e.g., a first party application store). In other embodiments, the application store is a third-party application store (e.g., an application store that is provided by another application store, downloaded via a network, and/or read from a storage device).

Referring to FIG. 1A and FIG. 1E, application 60 obtains information (e.g., step 10). In some embodiments, at step 10, information is obtained from at least one hardware component of the device 50. In some embodiments, at step 10, information is obtained from at least one software module (e.g., set of instructions) of the device 50. In some embodiments, at step 10, information is obtained from at least one hardware component external to the device 50 (e.g., a peripheral device, an accessory device, a server, etc.). In some embodiments, the information obtained at step 10 includes audio information, wake word information, text content information (e.g., received directly, included in a provided document, etc.), positional information, time information, notification information, user information, environment information, electronic device state information, weather information, media information, historical information, event information, hardware information, and/or motion information. In some embodiments, in response to and/or after obtaining the information at step 10, application 60 provides the information to a system (e.g., step 20).

In some embodiments, the system (e.g., 80 shown in FIG. 1D) is an operating system hosted on the device 50. In some embodiments, the system (e.g., 80 shown in FIG. 1D) is an external device (e.g., a server, a peripheral device, an accessory, a personal computing device, etc.) that includes an operating system.

Referring to FIG. 1B and FIG. 1F, application 60 obtains information (e.g., step 30). In some embodiments, the information obtained at step 30 includes audio information, wake word information, text content information (e.g., received directly, included in a provided document, etc.), positional information, time information, notification information, user information, environment information electronic device state information, weather information, media information, historical information, event information, hardware information and/or motion information. In response to and/or after obtaining the information at step 30, application 60 performs an operation with the information (e.g., step 40). In some embodiments, the operation performed at step 40 includes: providing information to an application based on the information, obtaining data from an application based on the information, providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 85 based on the information.

In some embodiments, one or more steps of the method of FIG. 1A and/or the method of FIG. 1B is performed in response to a trigger. In some embodiments, the trigger includes detection of an event, a notification received from system 85, a user input, and/or a response to a call to an API provided by system 85.

In some embodiments, the instructions of application 60, when executed, control device 50 to perform the method of FIG. 1A and/or the method of FIG. 1B by calling an application programming interface (API) (e.g., API 90) provided by system 85. In some embodiments, application 60 performs at least a portion of the method of FIG. 1A and/or the method of FIG. 1B without calling API 90.

In some embodiments, one or more steps of the method of FIG. 1A and/or the method of FIG. 1B includes calling an API (e.g., API 90) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1C, device 50 is illustrated. In some embodiments, device 50 is a personal computing device, a smart phone, a smart watch, a fitness tracker, a head mounted display (HMD) device, a media device, a communal device, a speaker, a television, and/or a tablet. As illustrated in FIG. 1C, device 50 includes application 60 and operating system (e.g., system 85 shown in FIG. 1D). Application 60 includes application implementation instructions 70 and API calling instructions 80. System 85 includes API 90 and implementation instructions 95. It should be recognized that device 50, application 60, and/or system 85 can include more, fewer, and/or different components than illustrated in FIGS. 1C and 1D.

In some embodiments, application implementation instructions 70 is a software module that includes a set of one or more computer-executable instructions. In some embodiments, the set of one or more instructions of instructions 70 correspond to one or more operations performed by application 60. For example, when application 60 is a voice assistant application, application implementation instructions 70 can include operations to process a voice assistant request. In another example, when application 60 is a text content summarization application, application implementation instructions 70 can include operations to process a text content summarization request. In some embodiments, application implementation instructions 70 communicates with API calling instructions to communicate with system 85 via API 90 (shown in FIG. 1D).

In some embodiments, API-calling instructions 80 is a software module that includes a set of one or more computer-executable instructions.

In some embodiments, implementation instructions 95 is a software module that includes a set of one or more computer-executable instructions.

In some embodiments, API 90 is a software module that includes a set of one or more computer-executable instructions. In some embodiments, API 90 provides an interface that allows a different set of instructions (e.g., API calling instructions 80) to access and/or use one or more functions, methods, procedures, data structures, classes, and/or other services provided by implementation instructions 95 of system 85. For example, API-calling instructions 80 can access a feature of implementation instructions 95 through one or more API calls or invocations (e.g., embodied by a function or a method call) exposed by API 90 and can pass data and/or control information using one or more parameters via the API calls or invocations. In some embodiments, API 90 allows application 60 to use a service provided by a Software Development Kit (SDK) library. In other embodiments, application 60 incorporates a call to a function or method provided by the SDK library and provided by API 90 or uses data types or objects defined in the SDK library and provided by API 90. In some embodiments, API-calling instructions 80 makes an API call via API 90 to access and use a feature of implementation instructions 95 that is specified by API 90. In such embodiments, implementation instructions 95 can return a value via API 90 to API-calling instructions 80 in response to the API call. The value can report to application 60 the capabilities or state of a hardware component of device 50, including those related to aspects such as input capabilities and state, output capabilities and state, processing capability, power state, storage capacity and state, and/or communications capability. In some embodiments, API 90 is implemented in part by firmware, microcode, or other low-level logic that executes in part on the hardware component.

In some embodiments, API 90 allows a developer of API-calling instructions 80 (which can be a third-party developer) to leverage a feature provided by implementation instructions 95. In such embodiments, there can be one or more set of API-calling instructions (e.g., including API-calling instructions 80) that communicate with implementation instructions 95. In some embodiments, API 90 allows multiple sets of API-calling instructions written in different programming languages to communicate with implementation instructions 95 (e.g., API 90 can include features for translating calls and returns between implementation instructions 95 and API-calling instructions 80) while API 90 is implemented in terms of a specific programming language. In some embodiments, API-calling instructions 80 calls APIs from different providers such as a set of APIs from an OS provider, another set of APIs from a plug-in provider, and/or another set of APIs from another provider (e.g., the provider of a software library) or creator of the another set of APIs.

Examples of API 90 can include one or more of: a voice assistant API, a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, a text content summarization API, and/or image processing API. In some embodiments the sensor API is an API for accessing data associated with a sensor of device 50. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 95 is a system (e.g., operating system, server system) software module (e.g., a collection of computer-readable instructions) that is constructed to perform an operation in response to receiving an API call via API 90. In some embodiments, implementation instructions 95 is constructed to provide an API response (via API 90) as a result of processing an API call. By way of example, implementation instructions 95 and API-calling instructions 80 can each be any one of an operating system, a library, a device driver, an API, an application program, or other module. It should be understood that implementation instructions 95 and API-calling instructions 80 can be the same or different type of software module from each other. In some embodiments, implementation instructions 95 is embodied at least in part in firmware, microcode, or other hardware logic.

In some embodiments, implementation instructions 95 returns a value through API 90 in response to an API call from API-calling instructions 80. While API 90 defines the syntax and result of an API call (e.g., how to invoke the API call and what the API call does), API 90 might not reveal how implementation instructions 95 accomplishes the function specified by the API call. Various API calls are transferred via the one or more application programming interfaces between API-calling instructions 80 and implementation instructions 95. Transferring the API calls can include issuing, initiating, invoking, calling, receiving, returning, and/or responding to the function calls or messages. In other words, transferring can describe actions by either of API-calling instructions 80 or implementation instructions 95. In some embodiments, a function call or other invocation of API 90 sends and/or receives one or more parameters through a parameter list or other structure.

In some embodiments, implementation instructions 95 provides more than one API, each providing a different view of or with different aspects of functionality implemented by implementation instructions 95. For example, one API of implementation instructions 95 can provide a first set of functions and can be exposed to third party developers, and another API of implementation instructions 95 can be hidden (e.g., not exposed) and provide a subset of the first set of functions and also provide another set of functions, such as testing or debugging functions which are not in the first set of functions. In some embodiments, implementation instructions 95 calls one or more other components via an underlying API and thus be both a set of API calling instructions and a set of implementation instructions. It should be recognized that implementation instructions 95 can include additional functions, methods, classes, data structures, and/or other features that are not specified through API 90 and are not available to API calling instructions 80. It should also be recognized that API calling instructions 80 can be on the same system as implementation instructions 95 or can be located remotely and access implementation instructions 95 using API 90 over a network. In some embodiments, implementation instructions 95, API 90, and/or API-calling instructions 80 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

FIG. 1G illustrates a block diagram of different components of a system 100 that can be configured to implement the various techniques described herein, according to some embodiments. As shown in FIG. 1G, the system 100 can include a client computing device 102 and a server computing device 106. It is noted that, in the interest of simplifying this disclosure, the client computing device 102 and the server computing device 106 are discussed in singular capacities. In that regard, it should be appreciated that the system 100 can include any number of client computing devices 102 and server computing devices 106, consistent with the scope of this disclosure.

According to some embodiments, the client computing device 102 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IOT) computing device, and so on. According to some embodiments, the server computing device 106 can represent any form of computing device, such as a blade server, a rack server, a tower server, and so on. It is noted that the foregoing examples are not meant to be limiting, and that the client computing device 102/server computing device 106 can represent any type, form, etc., of computing device, consistent with the scope of this disclosure.

As shown in FIG. 1G, and as described in greater detail herein, the client computing device 102 can issue queries 104 to a server computing device 106 (e.g., via the Internet, a network connection, etc.), where, in turn, the server computing device 106 can generate and provide results 128 to the client computing device 102 (e.g., over the aforementioned connections, different connections, etc.). According to some embodiments, and as shown in FIG. 1G, the client computing device 102 can store conversation history information 103, which can include information associated with the queries 104, the results 128, etc., as well as any other type, form, etc., of information, at any level of granularity, pertaining to the interactions between the client computing device 102 and the server computing device 106. According to some embodiments, the conversation history information 103 can also represent/store other information associated with a user/the users of the client computing device 102, such as user account information, demographic-related information, device-related information (associated with the client computing device 102), and so on. It is noted that the conversation history information 103 can be stored locally on the client computing device 102, the server computing device 106, and/or any other computing devices, which can improve overall efficiency, enable synchronization functionalities, and so on. As described in greater detail herein, the conversation history information 103 can be utilized to guide, personalize, etc., the results 128 that are generated and provided by the server computing device 106 to the client computing device 102.

As shown in FIG. 1G, the server computing device 106 can implement a query processor 108. According to some embodiments, the query processor 108 can be configured to receive a given query 104 and extract relevant information from the query 104 in order to process the query 104. The relevant information can include, for example, information about the client computing device 102 that issued the query 104 (so that results 128 can be provided back to the client computing device 102), conversation history information 103 associated with the client computing device 102 (e.g., when the server computing device 106 does not manage the conversation history information 103), text content (or a document that includes text content), and the like.

In some cases, the relevant information can also include instructions that inform how a summary of the text content should be generated, output, etc. For example, the instructions can indicate, for the summary, a desired length (e.g., number of sentences, paragraphs, etc.), one or more areas of the text content on which to focus (e.g., key points, details, narrative, etc.), a tone (e.g., formal, informal, neutral, etc.), an intended purpose (e.g., academic, business, general, etc.), a perspective (e.g., first, second, third, etc., person), an audience (e.g., an age of a person for whom the summary is being generated), an emphasis (e.g., data and statistics, quotes and dialogue, implications and analysis, etc.), a structure (e.g., sentences, paragraphs, bullet points, etc.), and so on. It is noted that the foregoing examples are not meant to be limiting, and that the query 104 can include any amount, type, form, etc., of information, at any level of granularity, that can inform how the summary should be generated, output, etc., for the text content included in the query 104, consistent with the scope of this disclosure.

As shown in FIG. 1G, the server computing device 106 can implement one or more machine learning models 110 configured to, for example, generate summaries of text content. The machine learning models 110 can represent any form of artificial intelligence (AI) models-such as small language models (SLMs), large language models (LLMs), rule-based models, ranking models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and so on. It is noted that the foregoing examples are not meant to be limiting, and that any number, type, form, etc., of AI model(s), can be implemented by the server computing device 106, consistent with the scope of this disclosure.

According to some embodiments, the query processor 108 can be aware of input limitations of a given machine learning model 110 that will be utilized to generate a summary of text content included in a query 104. In particular, the machine learning model 110 may have a numerical limit for text input that can be processed a single interaction, e.g., four thousand tokens, which typically translates to approximately three thousand words (depending, for example, on the complexity of the text, the length of the words, etc.). The input limit can be based on, for example, inherent, enforced, etc., limitations associated with the machine learning model 110 itself, hardware/software that implements the machine learning model 110, and so on. It is noted that the foregoing examples are not meant to be limiting, and that the machine learning models 110 described herein can be associated with any number, type, form, etc., of input limit(s), at any level of granularity, consistent with the scope of this disclosure, and that the techniques described herein can be adjusted to accommodate the input limits.

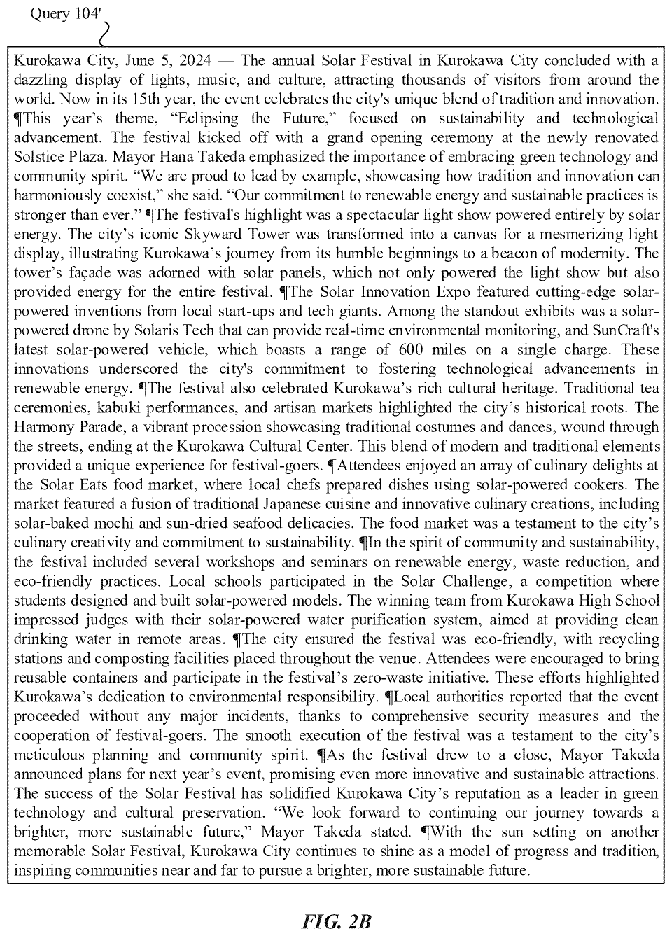

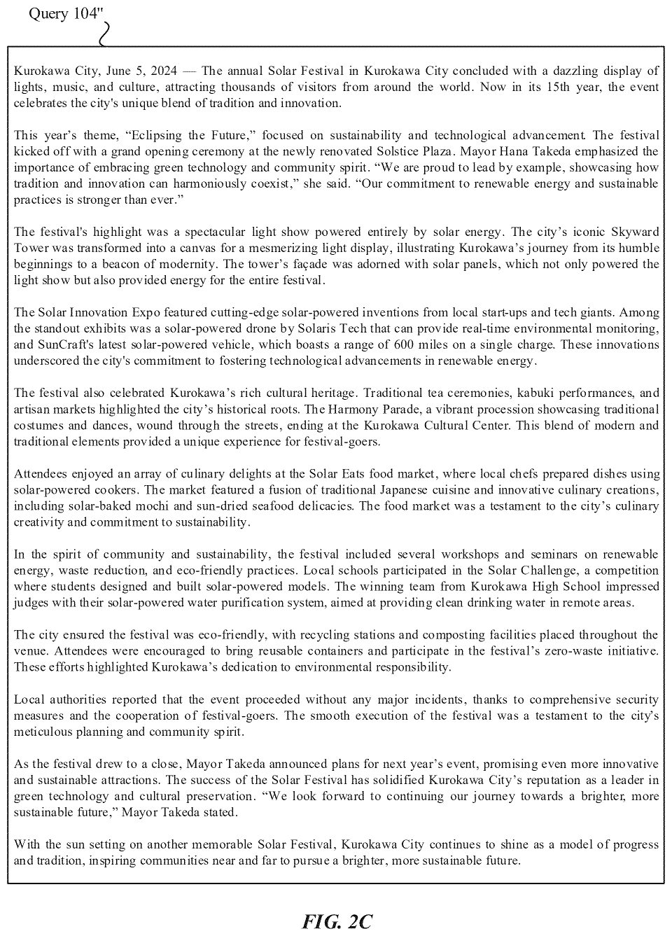

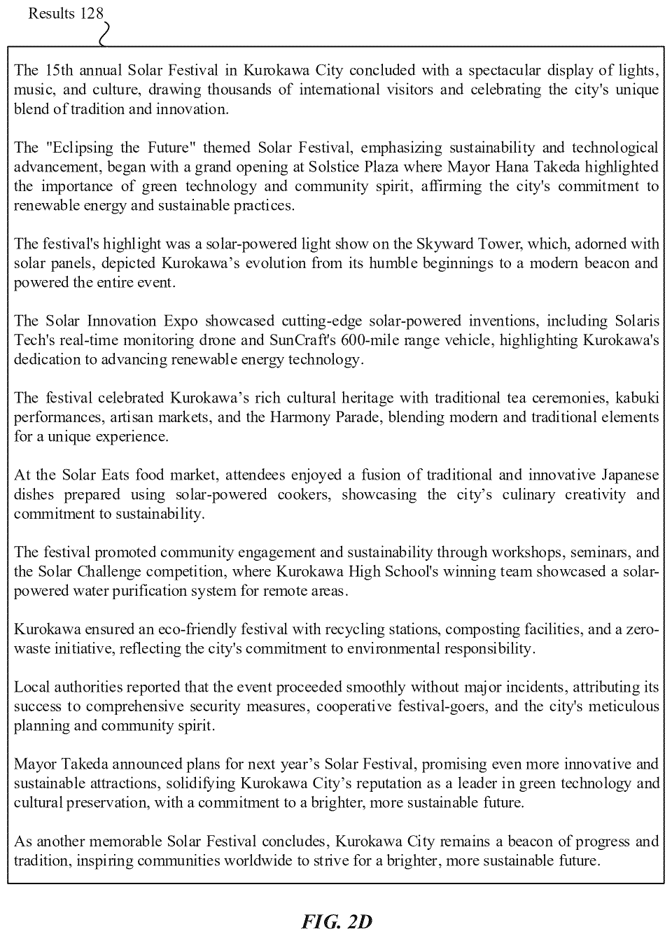

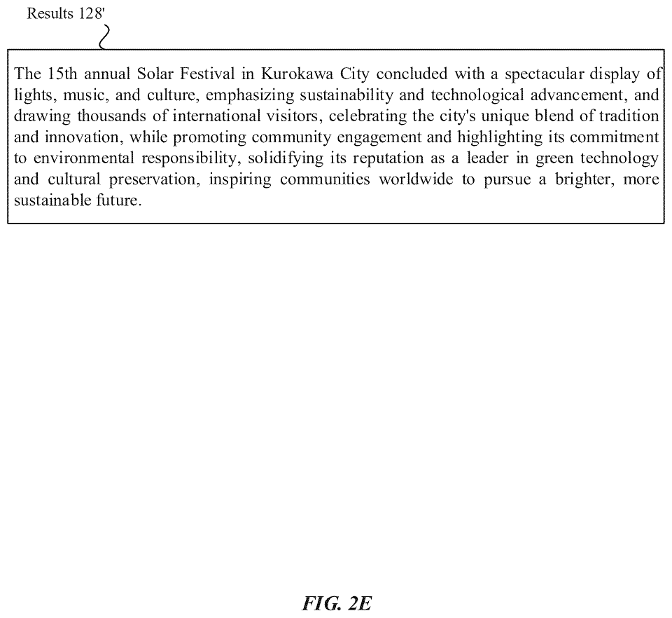

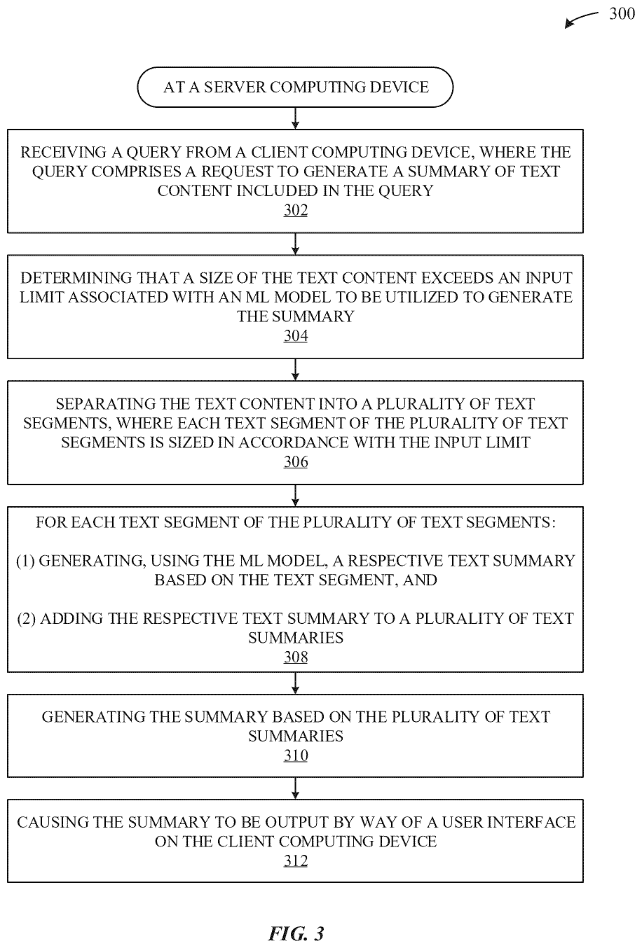

According to some embodiments, the query processor 108 can be configured to analyze the text content to determine whether the text content, at least in its entirety, would exceed the input limitations of the machine learning model 110. Under one approach, the query processor 108 can implement a tokenizer that performs tokenization of the text content, cleaning of the text content, normalization of the text content, etc., to determine whether the number of tokens exceeds the input limitations of the machine learning model 110. If the query processor 108 determines that the number of tokens does not exceed the input limitations of the machine learning model 110, then the text content can be provided to the machine learning model 110 for processing (i.e., without performing the segmentation techniques described herein). Conversely, if the query processor 108 determines that the number of tokens does exceed the input limitations of the machine learning model 110, then the query processor 108 can implement the techniques described herein to effectively eliminate, circumvent, etc., the aforementioned input limitations of the machine learning model 110. A more detailed explanation of these techniques is provided below in conjunction with FIGS. 2A-2E and 3.

According to some embodiments, when the query processor 108 obtains a summary for the text content (e.g., in accordance with the techniques described herein), the query processor 108 can generate results 128 based on the query 104, the summary, and any other relevant information. According to some embodiments, query processor 108 can implement any number, type, form, etc., of AI model(s) to filter redundant, inaccurate, irrelevant, etc., information included in the results 128. The query processor 108 can also be configured to identify and eliminate information considered to be “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content. To implement this functionality, the query processor 108 can employ one or more LLMs that analyze the query 104, the summary, etc., to identify content, if any, that should not be included in the summary. According to some embodiments, the query processor 108 can be configured to omit the content, to flag the content for review/careful consideration (e.g., by a user of the client computing device 102), and so on.

According to some embodiments, when the query processor 108 generates results 128 for a given query 104, the server computing device 106 can be configured to provide the results 128 to the client computing device 102 (that issued the query 104). The results 128 can be organized using any approach that is feasible for sending the results 128 to the client computing device 102 in a manner that is compatible with/understood by the client computing device 102. In turn the client computing device 102 can display the results 128 using the appropriate applications, user interfaces, etc., to enable a user of the client computing device 102 to interact with the aforementioned assets. A more detailed explanation of how the client computing device 102 can enable its user to interact with the aforementioned assets is provided below in conjunction with FIGS. 2A-2E and 3.

As a brief aside, it is noted that the server computing device 106 (e.g., the query processor 108, the machine learning models 110, etc.) can be configured to interface with the appropriate knowledge sources 118 to enable, supplement, etc., the techniques that the server computing device 106 is configured to implement. According to some embodiments, the server computing device 106 can employ any number/type of AI models to effectively identify the appropriate knowledge source(s) 118 with which to engage. According to some embodiments, and as shown in FIG. 1G, the knowledge sources 118 can include, for example, web search engines 120, question and answer (Q&A) knowledge sources 122, knowledge graphs 124, approximate nearest-neighbor (ANN) indexes 126, and so on. It is noted that the knowledge sources 118 illustrated in FIG. 1G and described herein should not be construed as limiting, and that the server computing device 106 can be configured to access any number, type, form, etc., of knowledge source(s) 118 capable of receiving queries and providing responses, consistent with the scope of this disclosure.

It is noted that the logical breakdown of the entities illustrated in FIG. 1G—as well as the logical flow of the manner(s) in which such entities communicate—should not be construed as limiting. On the contrary, any of the entities illustrated in FIG. 1G can be separated into additional entities within the system 100, combined together within the system 100, or removed from the system 100, consistent with the scope of this disclosure. It should additionally be understood that the computing devices can include additional entities that enable the implementation of the various techniques described herein, consistent with the scope of this disclosure. It should further be understood that the various entities described herein can be implemented using software-based or hardware-based approaches, consistent with the scope of this disclosure.

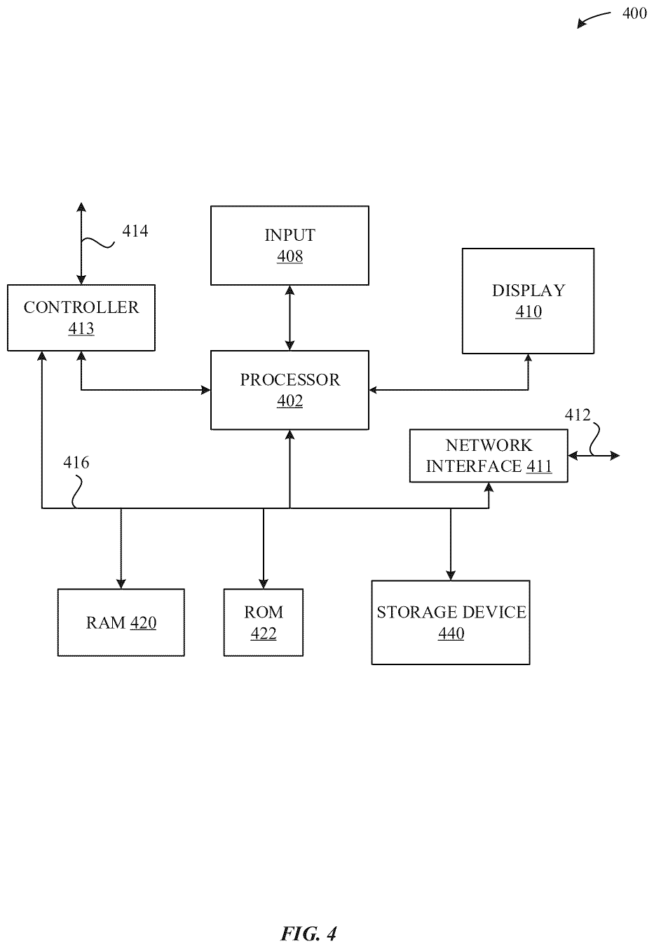

Additionally, it should be understood that the various components of the computing devices illustrated in FIG. 1G are presented at a high level in the interest of simplification. For example, although not illustrated in FIG. 1G, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another. A more detailed explanation of these hardware components is provided below in conjunction with FIG. 4.

Accordingly, FIG. 1G provides an overview of the manner in which the system 100 can implement the various techniques described herein, according to some embodiments. A more detailed breakdown of the manner in which these techniques can be implemented will now be provided below in conjunction with FIGS. 2A-2C and 3A-3C.

FIGS. 2A-2E illustrate conceptual diagrams of how the server computing device 106 can process an example query 104 into results 128, according to some embodiments. These FIGS. are described and referenced below in conjunction with FIG. 3.

FIG. 3 illustrates a method 300 for processing text using machine learning (ML) models, according to some embodiments. As shown in FIG. 3, the method 300 begins at step 302, where the server computing device 106 receives a query 104 from a client computing device 102, and the query 104 comprises a request to generate a summary of text content included in the query. An example of the query 104 is illustrated in FIG. 2A, which, as shown, includes text content that is relatively lengthy, disorganized (i.e., no paragraphs, line breaks, etc.), and so on.

At step 304, the server computing device 106—specifically, the query processor 108—determines that a size of the text content exceeds an input limit of an ML model (e.g., a machine learning model 110) to be utilized to generate the requested summary. Consider, for example, the text content illustrated in FIG. 2A, which includes five hundred seventy-nine words. Under an example configuration of a tokenizer implemented by the query processor 108 (that is compatible with the machine learning model 110), the tokenizer splits the text content at four-character intervals, e.g., including spaces and punctuation. Consider further that the text content—which includes four thousand ninety-six characters—is split into one thousand tokens. Consider further that the input limit of the machine learning model 110 is two hundred tokens. In this regard, the machine learning model 110 is limited to processing one-fifth (i.e., two hundred) of the one thousand tokens during each processing interval.

To address this limitation, at step 306, the server computing device 106 separates the text content into a plurality of text segments, where each text segment of the plurality of text segments is sized in accordance with the input limit. In particular, the text content can be separated into the plurality of segments, where each text segment of the plurality of text segments, when translated into corresponding tokens, results in a number of tokens that is less than or equal to the input limit of the machine learning model 110.

Different approaches for segmenting the text content can be utilized. Under one approach, the text content can be separated based on different characters that are included in the text content. For example, the text content can be separated in accordance with paragraphs (e.g., when line break characters are present), sentences (e.g., when period (“.”) characters are present), words (when no period (“.”) characters are present, but space characters are present), characters (when no spaces are present), or the like. The appropriate approach for separating the text content can be determined by the query processor 108 based on, for example, the characters included in the text content, the layout of the text content, and so on. Under another approach, the language of the text content can be analyzed (e.g., by one or more machine learning models 110 employed by the query processor 108) to identify transitional words, phrases, etc., that are indicative of logical breaks, transitions, etc., that take place within the text content. It is noted that the foregoing examples are not meant to be limiting, and that the text content can be segmented based on any amount, type, form, etc., of information, at any level of granularity, consistent with the scope of this disclosure. It should also be appreciated that the foregoing segmentation approaches can be modified, tuned, etc., to effectively accommodate different types of text content, such as text content written in different languages, contiguous text content (e.g., large numbers, alphanumeric strings, etc.), and so on, consistent with the scope of this disclosure.

An example segmentation of the text content of FIG. 2A is illustrated in FIGS. 2B-2C. In particular, the example segmentation is represented by the paragraph symbols (“¶”) in FIG. 2B and the line breaks in FIG. 2C. As shown in FIG. 2C, the first segment (“Kurokawa City, June 5 . . . ”) includes forty-six words and two hundred eighty-nine characters. In this regard, because the aforementioned tokenizer is configured to split text input into four-character chunks, tokenizing the first segment would result in approximately seventy tokens, which is well under the two hundred token input limit of the machine learning model 110. As shown in FIG. 2C, the remaining segments are similar in size to that of the first segment. In this regard, tokenizing the remaining segments also will result in segments having respective token counts that are well under the two hundred token input limit of the machine learning model 110.

Additionally, and according to some embodiments, the query processor 108 can be configured to analyze one or more of the text segments individually, relative to at least one other text segment (e.g., text segments that precede and/or follow the text segment), and so on, to generate a relevance score that indicates a level of usefulness of the text segment with respect to summarizing the text content. A given relevance score for a text segment can also be assigned based on conversation history information 103 that indicates whether the user typically is interested or disinterested in the content of the text segment (which can be indicated, provided, etc., by way of user interfaces provided by the client computing device 102, as described below). In any case, the text content, in its segmented form after carrying out step 306, is prepared to be sequentially processed by the machine learning model 110 without violating the input limit of the machine learning model 110. In this manner, a user seeking to summarize the text content is not faced with manually separating the content into different segments, interacting with machine learning models 110 in an iterative fashion, and so on.

Accordingly, at step 308, the server computing device 106 performs the following steps for each text segment of the plurality of text segments: (1) generating, using the machine learning model 110, a respective text summary based on the text segment, and (2) adding the respective text summary to a plurality of text summaries. According to some embodiments, the machine learning model 110 can generate a summary of the text segment by leveraging a deep learning architecture that is trained on vast amounts of data to understand and generate human-like language. In particular, when given a text segment, the machine learning model 110 can process the text segment to identify key themes, concepts, and essential information, while filtering out redundant or non-essential details. The machine learning model 110 can utilize sophisticated algorithms to condense the text segment into a shorter version that retains the core meaning and critical points.

At step 310, the server computing device 106 generates the summary based on the plurality of text summaries. This can include, for example, combining the plurality of text summaries together, while keeping them logically separated as desired, e.g., through line breaks, page breaks, etc. An example of the results of steps 308-310 is illustrated in FIG. 2D, where each text segment of the eleven text segments (established in FIGS. 2B-2C) is replaced by a respective summary that constitutes a distillation of the text segment, and where each summary is separated by a line break. In this regard, the respective summaries constitute a full summary that is nearly half the length of the text content included in the query 104. It should be understood that the machine learning model 110 can be configured to generate summaries that are smaller or greater in length than those illustrated in FIG. 2D, depending on, for example, the amount of information included in the text segments, a desired summary length (e.g., indicated in the query 104, the conversation history information 103, etc.), and so on.

As a brief aside, in some cases, it can be desirable to reduce the size of the summary that is generated by way of the steps of the method 300. In this regard, if a tokenization of the summary results in a number of tokens that exceeds the input limit of the machine learning model 110, then steps 304-310 can be performed on the summary (as if it were received at step 302 as text content). Otherwise, the summary can be provided to the machine learning model 110 with a request to generate an updated summary that is reduced in size relative to the summary.

Finally, at step 312, the server computing device 106 causes the summary to be output by way of a user interface on the client computing device. According to some embodiments, the summary can include, for one or more of the text summaries (on which the summary is based), information that links the text summary to one or more areas of the text content that the machine learning model 110 used to derive the text summary. This information can provide a variety of useful features to be implemented. For example, when a given text summary is linked to one or more areas of the text content, the client computing device 102 can indicate (e.g., through one or more affordances associated with the text summary) that the one or more areas of the text content can be accessed, viewed, etc. In turn, when a selection is made to access at least one of the one or more areas of the text content, the client computing device 102 can display the one or more areas of the text content (e.g., by way of an overlay, a side-by-side view, a transition, etc.). The user interface can also enable the user to indicate particular areas of the summary that they find to be interesting/uninteresting, which can then be used to adjust the conversation history information 103 so that subsequent summaries generated for the user are more relevant/personalized to the user. It is noted that the foregoing examples are not meant to be limiting, and that the client computing device 102 can implement any number, type, form, etc., of user interface(s), at any level of granularity, to effectively enable linkages between summarized text content and underlying text content to be explored, consistent with the scope of this disclosure.

FIG. 4 illustrates a detailed view of a computing device 400 that can be used to implement the various components described herein, according to some embodiments. In particular, the detailed view illustrates various components that can be included in the computing devices described above in conjunction with FIG. 1.

As shown in FIG. 4, the computing device 400 can include a processor 402 that represents a microprocessor or controller for controlling the overall operation of computing device 400. The computing device 400 can also include a user input device 408 that allows a user of the computing device 400 to interact with the computing device 400. For example, the user input device 408 can take a variety of forms, such as a button, keypad, dial, touch screen, audio input interface, visual/image capture input interface, input in the form of sensor data, etc. Furthermore, the computing device 400 can include a display 410 (screen display) that can be controlled by the processor 402 to display information to the user. A data bus 416 can facilitate data transfer between at least a storage device 440, the processor 402, and a controller 413. The controller 413 can be used to interface with and control different equipment through an equipment control bus 414. The computing device 400 can also include a network/bus interface 411 that couples to a data link 412. In the case of a wireless connection, the network/bus interface 411 can include a wireless transceiver.

The computing device 400 also includes a storage device 440, which can comprise a single disk or a plurality of disks (e.g., SSDs), and includes a storage management module that manages one or more partitions within the storage device 440. In some embodiments, storage device 440 can include flash memory, semiconductor (solid state) memory or the like. The computing device 400 can also include a Random-Access Memory (RAM) 420 and a Read-Only Memory (ROM) 422. The ROM 422 can store programs, utilities, or processes to be executed in a non-volatile manner. The RAM 420 can provide volatile data storage, and stores instructions related to the operation of the computing devices described herein.

In some embodiments, one or more of process 300 (e.g., FIG. 3) is performed at a first computer system (as described herein) via a system process (e.g., an operating system process and/or a server system process) that is different from one or more applications executing and/or installed on the first computer system.

In some embodiments, one or more of process 300 (e.g., FIG. 3) is performed at a first computer system (as described herein) by an application that is different from a system process.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device).

In some embodiments, the set of implementation instructions is included in the device that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A method, comprising, by a server computing device:
receiving a query from a client computing device, wherein the query comprises a request to generate a summary of text content included in the query;
determining that a size of the text content exceeds an input limit associated with an ML model to be utilized to generate the summary;
separating the text content into a plurality of text segments, wherein each text segment of the plurality of text segments is sized in accordance with the input limit;
for each text segment of the plurality of text segments:
generating, using the ML model, a respective text summary based on the text segment, and
adding the respective text summary to a plurality of text summaries;
generating the summary based on the plurality of text summaries; and
causing the summary to be output by way of a user interface on the client computing device.

2. The method of claim 1, wherein each text segment of the plurality of text segments is separated by a line break, a period, a space, a character, or a respective language-based transitional phrase.

3. The method of claim 2, wherein each text segment of the plurality of text segments is separated by a character when no line breaks, periods, or spaces are included in the text content.

4. The method of claim 2, wherein, for a given text segment of the plurality of text segments, the respective language-based transitional phrase is identified using at least one ML model that assigns, to the text segment, a transitional phrase probability that exceeds a particular threshold.

5. The method of claim 1, further comprising, for each text segment of the plurality of text segments:
associating the respective text summary with the text segment to enable the text segment to be recalled by the client computing device in association with the respective text summary.

6. The method of claim 1, wherein generating the summary based on the plurality of text summaries comprises:
combining the plurality of text summaries into a text output, wherein each text summary of the plurality of text summaries is separated within the text output using a line break.

7. The method of claim 1, further comprising, in response to receiving a second query from the client computing device to generate a second summary of second text content included in the summary:
determining that a second size of the second text content exceeds the input limit associated with the ML model;
separating the second text content into a plurality of second text segments, wherein each second text segment of the plurality of second text segments is sized in accordance with the input limit;
for each second text segment of the plurality of text segments:
generating, using the ML model, a respective second text summary based on the second text segment, and
adding the respective second text summary to a plurality of second text summaries;
generating the second summary based on the plurality of second text summaries; and
causing the second summary to be output by way of the user interface on the client computing device.

8. The method of claim 7, further comprising, prior to causing the client computing device to output the summary by way of the user interface, and prior to receiving the second query:
indicating, to the client computing device, an overall size of the summary, to cause the client computing device to provide, by way of the user interface, an option to reduce the overall size of the summary, wherein the second query is issued in conjunction with receiving a selection of the option.

9. The method of claim 1, further comprising, prior to establishing the plurality of text summaries:
for each text segment of the plurality of text segments:
utilizing at least one ML model to establish a relevance score that quantifies an overall importance of the text segment relative to other text segments included in the plurality of text segments; and
removing the text segment from the plurality of text segments when the relevance score satisfies a particular threshold.

10. The method of claim 1, wherein the text content is extracted from a word processing document.

11. A non-transitory computer readable storage medium configured to store instructions that, when executed by at least one processor included in a server computing device, cause the server computing device to carry out steps that include:
receiving a query from a client computing device, wherein the query comprises a request to generate a summary of text content included in the query;
determining that a size of the text content exceeds an input limit associated with an ML model to be utilized to generate the summary;
separating the text content into a plurality of text segments, wherein each text segment of the plurality of text segments is sized in accordance with the input limit;
for each text segment of the plurality of text segments:
generating, using the ML model, a respective text summary based on the text segment, and
adding the respective text summary to a plurality of text summaries;
generating the summary based on the plurality of text summaries; and
causing the summary to be output by way of a user interface on the client computing device.

12. The non-transitory computer readable storage medium of claim 11, wherein each text segment of the plurality of text segments is separated by a line break, a period, a space, a character, or a respective language-based transitional phrase.

13. The non-transitory computer readable storage medium of claim 12, wherein each text segment of the plurality of text segments is separated by a character when no line breaks, periods, or spaces are included in the text content.

14. The non-transitory computer readable storage medium of claim 12, wherein, for a given text segment of the plurality of text segments, the respective language-based transitional phrase is identified using at least one ML model that assigns, to the text segment, a transitional phrase probability that exceeds a particular threshold.

15. The non-transitory computer readable storage medium of claim 11, wherein the steps further include, for each text segment of the plurality of text segments:
associating the respective text summary with the text segment to enable the text segment to be recalled by the client computing device in association with the respective text summary.

16. The non-transitory computer readable storage medium of claim 11, wherein generating the summary based on the plurality of text summaries comprises:
combining the plurality of text summaries into a text output, wherein each text summary of the plurality of text summaries is separated within the text output using a line break.

17. The non-transitory computer readable storage medium of claim 11, wherein the steps further include, in response to receiving a second query from the client computing device to generate a second summary of second text content included in the summary:
determining that a second size of the second text content exceeds the input limit associated with the ML model;
separating the second text content into a plurality of second text segments, wherein each second text segment of the plurality of second text segments is sized in accordance with the input limit;
for each second text segment of the plurality of text segments:
generating, using the ML model, a respective second text summary based on the second text segment, and
adding the respective second text summary to a plurality of second text summaries;
generating the second summary based on the plurality of second text summaries; and
causing the second summary to be output by way of the user interface on the client computing device.

18. The non-transitory computer readable storage medium of claim 17, wherein the steps further include, prior to causing the client computing device to output the summary by way of the user interface, and prior to receiving the second query:
indicating, to the client computing device, an overall size of the summary, to cause the client computing device to provide, by way of the user interface, an option to reduce the overall size of the summary, wherein the second query is issued in conjunction with receiving a selection of the option.

19. The non-transitory computer readable storage medium of claim 11, wherein the steps further include, prior to establishing the plurality of text summaries:
for each text segment of the plurality of text segments:
utilizing at least one ML model to establish a relevance score that quantifies an overall importance of the text segment relative to other text segments included in the plurality of text segments; and
removing the text segment from the plurality of text segments when the relevance score satisfies a particular threshold.

20. The non-transitory computer readable storage medium of claim 11, wherein the text content is extracted from a word processing document.

21. A server computing device, comprising:
at least one processor; and
at least one memory storing instructions that, when executed by the at least one processor, cause the computing device to carry out steps that include:
receiving a query from a client computing device, wherein the query comprises a request to generate a summary of text content included in the query;
determining that a size of the text content exceeds an input limit associated with an ML model to be utilized to generate the summary;
separating the text content into a plurality of text segments, wherein each text segment of the plurality of text segments is sized in accordance with the input limit;
for each text segment of the plurality of text segments:
generating, using the ML model, a respective text summary based on the text segment, and
adding the respective text summary to a plurality of text summaries;
generating the summary based on the plurality of text summaries; and
causing the summary to be output by way of a user interface on the client computing device.

22. The server computing device of claim 21, wherein each text segment of the plurality of text segments is separated by a line break, a period, a space, a character, or a respective language-based transitional phrase.

23. The server computing device of claim 22, wherein each text segment of the plurality of text segments is separated by a character when no line breaks, periods, or spaces are included in the text content.

24. The server computing device of claim 22, wherein, for a given text segment of the plurality of text segments, the respective language-based transitional phrase is identified using at least one ML model that assigns, to the text segment, a transitional phrase probability that exceeds a particular threshold.

25. The server computing device of claim 21, wherein the steps further include, for each text segment of the plurality of text segments:
associating the respective text summary with the text segment to enable the text segment to be recalled by the client computing device in association with the respective text summary.

26. The server computing device of claim 21, wherein generating the summary based on the plurality of text summaries comprises:
combining the plurality of text summaries into a text output, wherein each text summary of the plurality of text summaries is separated within the text output using a line break.

27. The server computing device of claim 21, wherein the steps further include, in response to receiving a second query from the client computing device to generate a second summary of second text content included in the summary:
determining that a second size of the second text content exceeds the input limit associated with the ML model;
separating the second text content into a plurality of second text segments, wherein each second text segment of the plurality of second text segments is sized in accordance with the input limit;
for each second text segment of the plurality of text segments:
generating, using the ML model, a respective second text summary based on the second text segment, and
adding the respective second text summary to a plurality of second text summaries;
generating the second summary based on the plurality of second text summaries; and
causing the second summary to be output by way of the user interface on the client computing device.

28. The server computing device of claim 27, wherein the steps further include, prior to causing the client computing device to output the summary by way of the user interface, and prior to receiving the second query:
indicating, to the client computing device, an overall size of the summary, to cause the client computing device to provide, by way of the user interface, an option to reduce the overall size of the summary, wherein the second query is issued in conjunction with receiving a selection of the option.

29. The server computing device of claim 21, wherein the steps further include, prior to establishing the plurality of text summaries:
for each text segment of the plurality of text segments:
utilizing at least one ML model to establish a relevance score that quantifies an overall importance of the text segment relative to other text segments included in the plurality of text segments; and
removing the text segment from the plurality of text segments when the relevance score satisfies a particular threshold.

30. The server computing device of claim 21, wherein the text content is extracted from a word processing document.
